(19) United States
(12) Patent Application Publication
(10) Pub. No.: US 2026/0172469 A1
(43) Pub. Date: Jun. 18, 2026

(54) MESH-BASED NETWORK DEVICE

(71) Applicant: SAMSUNG ELECTRONICS CO., LTD., Suwon-si (KR)

(72) Inventor: Jonghoon KANG, Suwon-si (KR)

(73) Assignee: SAMSUNG ELECTRONICS CO., LTD., Suwon-si (KR)

(21) Appl. No.: 19/216,214

(22) Filed: May 22, 2025

(30) Foreign Application Priority Data
Dec. 16, 2024 (KR) 10-2024-0187553

(51) Int. Cl. H04L 67/10

(52) U.S. Cl. CPC H04L 67/10

(57) ABSTRACT

A system includes a plurality of nodes arranged in rows and columns in a mesh network, and a plurality of links that connect the plurality of nodes, the plurality of links including first links in a first direction and second links in a second direction, the first direction being one of a row direction or a column direction and the second direction being the other of the row direction or a column direction. At least one of the first links and the second links has a first bandwidth different than a second bandwidth of third links, among the plurality of links, wherein one or more nodes, among the plurality of nodes, located at cross points of the first links and the second links are defined as one or more root nodes, and the one or more root nodes are configured to perform collective communication performed between the plurality of nodes.

### CROSS-REFERENCE TO RELATED APPLICATIONS

This application is based on and claims the benefit of priority under 35 USC § 119(a) of Korean Patent Application No. 10-2024-0187553, filed on Dec. 16, 2024, in the Korean Intellectual Property Office, the entire disclosure of which is incorporated herein by reference for all purposes.

### BACKGROUND

### 1. Field

Embodiments of the disclosure relate to a mesh-based network device and a mesh-based network device system for performing collective communication and an operating method thereof.

### 2. Description of Related Art

Collective communication plays an important role in a large-scale parallel computing environment. In a system in which parallel computing is performed, data exchange between a plurality of processors or nodes is essential, and an efficient network structure and communication method are required for this purpose. In related art network designs, data transmission paths between particular nodes may often be limited, or it may be difficult to achieve balanced utilization of a network bandwidth. This may lead to data bottlenecks or system-wide performance degradation.

A mesh network may be one of the structural approaches to solve these issues and may have a characteristic of securing multiple data transmission paths by connecting a plurality nodes in a grid shape. A new mesh network structure and data processing method to maximize the utilization of network resources and improve data processing efficiency are in demand.

### SUMMARY

According to an aspect of the disclosure, there is provided a system including: a plurality of nodes arranged in rows and columns in a mesh-based network; and a plurality of links configured to connect the plurality of nodes, the plurality of links including first links in a first direction and second links in a second direction, the first direction being one of a row direction or a column direction and the second direction being the other of the row direction or a column direction, wherein at least one of the first links and the second links has a first bandwidth different than a second bandwidth of third links, among the plurality of links, wherein one or more nodes, among the plurality of nodes, located at cross points of the first links and the second links are defined as one or more root nodes, and wherein the one or more root nodes are configured to perform collective communication performed between the plurality of nodes.

The first links may be arranged between adjacent nodes connected in the row direction or the column direction of the mesh-based network.

Based on a number of the rows or a number of columns of the mesh-based network being an even number, the first links may include first first links and second first links arranged in two adjacent rows or two adjacent columns having the even number.

Based on a number of the rows or a number of columns of the mesh-based network being an odd number, the first links may be arranged only in one of the rows or the columns having the odd number.

The mesh-based network may be divided into a plurality of sections, each of the plurality of sections including a root node, among the one or more root nodes, and the root node of each of the plurality of sections may be configured to process collective communication performed within a corresponding section.

The mesh-based network may include a plurality of lower level nodes hierarchically connected to each of the one or more root nodes, and the plurality of lower level nodes may form a hierarchical tree structure.

The mesh-based network may include a mesh network expanded to a three-dimensional (3D) structure, and the 3D mesh network may include connections between the plurality of nodes arranged in a 3D direction.

According to an aspect of the disclosure, there is provided a system including a system including: a plurality of nodes arranged in rows and columns in a mesh-based network; and a plurality of links configured to connect the plurality of nodes, the plurality of links including first links in a first direction and second links in a second direction, the first direction being one of a row direction or a column direction and the second direction being the other of the row direction or a column direction, wherein at least one of the first links and the second links has a first bandwidth different than a second bandwidth of third links, among the plurality of links, and wherein each of the plurality of nodes is configured to: receive a data chunk, perform reduce-scatter operation of progressively combining the received data chunk with its own data and progressively transmitting the combined data to a root node of the mesh-based network through a number of adjacent nodes, perform an all-gather operation of distributing first data combined in the root node to a number of adjacent nodes, and complete collective communication by receiving second data distributed from the root node.

Each of the plurality of nodes may be further configured to simultaneously perform the reduce-scatter operation and the all-gather operation for different data chunks.

The root node may be located at cross points of the first links and the second links.

Each of the plurality of nodes may be further configured to partition the data chunk into logical chunks and transmit the logical chunks to each physical link.

Each of the plurality of nodes may be further configured to simultaneously transmit two physical chunks to different adjacent nodes.

At least one of the first links and the second links may have a first bandwidth different than a second bandwidth of third links, among the plurality of links.

The plurality of nodes may be further configured to transmit the data chunk using all of the plurality of links as data transmission paths.

According to an aspect of the disclosure, there is provided a method of performing collective communication, the method including: receiving a data chunk by each of a plurality of nodes connected to each other by a plurality of links in a mesh-based network, the plurality of links including first links in a first direction and second links in a second direction, the first direction being one of a row direction or a column direction and the second direction being the other of the row direction or a column direction; performing, by each of the plurality of nodes, reduce-scatter operation of progressively combining the received data chunk with its own data and progressively transmitting the combined data to a root node of the mesh-based network through a number of adjacent nodes; perfoming, by each of the plurality of nodes, an all-gather operation of distributing first data combined in the root node to a number of adjacent nodes; and completing, by each of the plurality of nodes, collective communication by receiving second data distributed from the root node, wherein at least one of the first links and the second links has a first bandwidth different than a second bandwidth of third links, among the plurality of links.

The reduce-scatter operation and the all-gather operation may be for different data chunks.

The root node may be located at cross points of the first links and the second links.

The method may further include: partitioning the data chunk into logical chunks; and transmitting the logical chunks to each physical link.

The completing of the collective communication may include transmitting the data chunk using all of the plurality of links of the mesh-based network as data transmission paths.

The first links may be arranged between adjacent nodes connected in the row direction or the column direction of the mesh-based network.

Other features and aspects will be apparent from the following detailed description, the drawings, and the claims.

### BRIEF DESCRIPTION OF DRAWINGS

FIG. 1A is a diagram illustrating a related art mesh-based network structure according to an example, FIG. 1B is a diagram illustrating a mesh-based network structure according to an embodiment, FIG. 1C is a diagram illustrating a related art mesh-based network structure according to another example, and FIG. 1D is a diagram illustrating a mesh-based network structure according to another embodiment.

FIGS. 2A to 2E are diagrams illustrating a mesh-based network structure and examples thereof according to an embodiment.

FIGS. 3A and 3B are diagrams illustrating a process in which four independent processors perform an all-reduce operation on four variables when executing the same application, according to an embodiment.

FIGS. 4A and 4B are diagrams illustrating a process of performing an all-reduce operation in a one-dimension (1D)-based network structure.

FIGS. 5A to 5H are diagrams illustrating a process of performing an all-reduce operation in a two-dimension (2D)-based network structure.

FIGS. 6A to 6J are diagrams illustrating a process of processing a message made up of five chunks in a 3×3 mesh-based network through an all-reduce operation.

FIGS. 7A to 7C are diagrams illustrating different methods of processing data in a mesh-based FatMesh structure.

FIGS. 8A and 8B are diagrams illustrating a process of processing data through a reduce-scatter operation and an all-gather operation in a mesh-based FatMesh structure according to an embodiment.

FIGS. 9A to 9H are diagrams illustrating a process of processing a message made up of five chunks through an all-reduce operation in a 3×3 mesh-based FatMesh network structure, according to an embodiment.

FIGS. 10A and 10B are diagrams illustrating a graphical representation of an overlap in a time axis of a reduce-scatter operation and an all-gather operation.

FIG. 11 is a diagram illustrating an example of a 2D FatMesh network structure according to an embodiment.

FIGS. 12A and 12B are diagrams illustrating a three-dimensional (3D) FatMesh structure.

FIG. 13 is a diagram illustrating a method of performing collective communication according to an embodiment.

FIG. 14 is a diagram illustrating an electronic device according to an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following structural or functional descriptions of embodiments are merely intended for the purpose of describing the embodiments and the embodiments may be implemented in various forms. The embodiments are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween. Likewise, expressions, for example, “between” and “immediately between” and “adjacent to” and “immediately adjacent to” may also be construed as described in the foregoing.

As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

The embodiments may be implemented in various forms of products such as a personal computer, laptop computer, tablet computer, smartphone, television, smart home appliance, intelligent car, kiosk, wearable device, etc. Hereinafter, embodiments will be described in detail with reference to the accompanying drawings. When describing the embodiments with reference to the accompanying drawings, like reference numerals refer to like components.

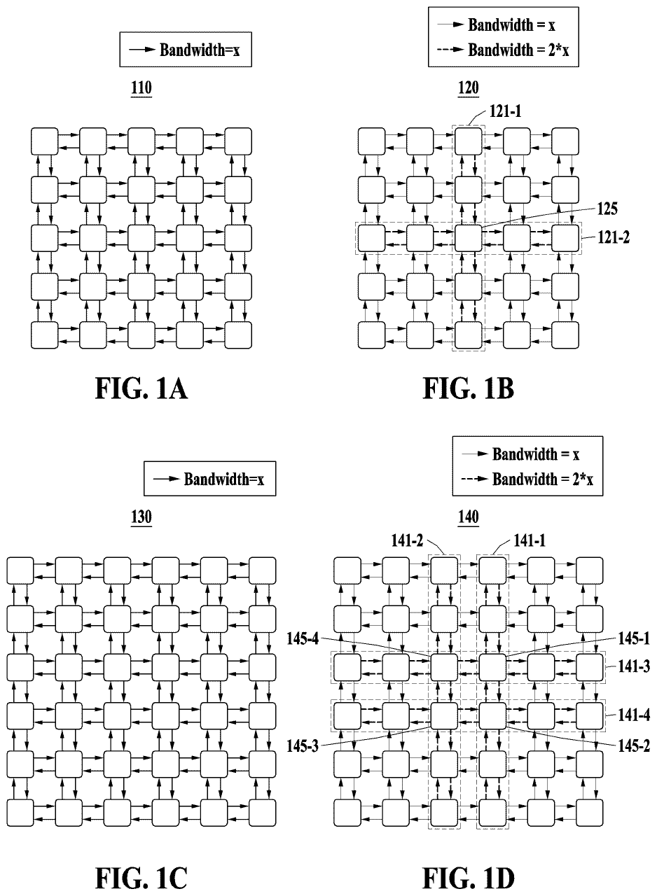

FIG. 1A is a diagram illustrating a related art mesh-based network structure according to an example, FIG. 1B is a diagram illustrating a mesh-based network structure according to an embodiment, FIG. 1C is a diagram illustrating a related art mesh-based network structure according to another example, and FIG. 1D is a diagram illustrating a mesh-based network structure according to another embodiment.

Referring to FIG. 1A, a 5×5 mesh network 110 is illustrated according to a related art. The 5×5 mesh network 110 may include a plurality of links indicating connections between a plurality of nodes. In the related art mesh network 110, all links may have the same bandwidth, and a characteristic in which a bandwidth in a particular direction is increased may not be applied. As such, in the mesh network 110, bottlenecks may occur when particular data is transmitted, and overall performance of the network may be degraded.

FIG. 1B illustrates a 5×5 mesh-based network 120 according to an embodiment of the disclosure. The mesh-based network 120 according to an embodiment may be referred to as a mesh-based FatMesh structure. The 5×5 mesh network 120 may include a plurality of links indicating connections between a plurality of nodes. Each of the plurality of links may represent a link between two adjacent nodes in the mesh network structure. The mesh-based FatMesh structure may be configured such that among the plurality of links, a bandwidth of first links 121-1 in a first direction or second links 121-2 in a second direction is set to an increased value compared to a bandwidth of another link (e.g., third links) in the same first direction or the same second direction. The first links 121-1 may be referred to as a first chain or a first chain of links, and the second links 121-2 may be referred to as a second chain or a second chain of links. According some embodiments of the disclosure, the first links 121-1 may include one or more first links representing connections between two or more first nodes in a same column, and the second links 121-2 may include one or more second links representing connections between two or more second nodes in a same row. For example, the first links 121-1 may represent the connections between all the nodes in the same column in the mesh structure and the second links 121-2 may represent the connections between all the nodes in the same row in the mesh structure. For example, among the plurality of links, the bandwidth of the first links 121-1 in the vertical direction or a column direction (e.g., same column) may be set to a value that is different (e.g., twice increased) than a bandwidth of another link (or chain of links) in the vertical direction. In another example, among the plurality of links, the bandwidth of the second link 121-2 in the horizontal direction or a row direction (e.g., same row) may be set to a value that is different (e.g., twice increased) than a bandwidth of another link (of chain of links) in the horizontal direction. A root node 125 may be located at cross points of the first links 121-1 and the second links 121-2, and the root node may be used as a central reference point in collective communication. For example, the root node 125 may combine and distribute data in a reduce-scatter operation or an all-gather operation.

FIG. 1C illustrates a 6×6 mesh network 130 according to a related art. The 6×6 mesh network 130 may include a plurality of nodes, and a plurality of links having the same bandwidth. In the 6×6 mesh network 130 structure, it may be difficult for all links to be used uniformly during large-scale parallel operations, and issues may occur where particular links become overloaded. As a result, the data transmission efficiency of the network may be reduced.

FIG. 1D illustrates a 6×6 mesh-based network 140 according to an embodiment. The mesh-based network 140 according to an embodiment may be referred to as a mesh-based FatMesh structure. The mesh-based FatMesh structure may be configured such that among a plurality of links, a bandwidth of links 141-1, 141-2, 141-3, or 141-4 in a particular direction is set to an increased value compared to a bandwidth of another link (or another chain of links)in the same direction. Additionally, a plurality of root nodes 145-1, 145-2, 145-3, and 145-4 may be located at cross points of the links 141-1, 141-2, 141-3, or 141-4. Each of the root nodes may process data communication within a network area and provide an optimal data flow.

The mesh-based FatMesh structure according to an embodiment may improve the issues of the related art and may efficiently utilize the network bandwidth. For example, the mesh-based FatMesh structure according to an embodiment may alleviate bottlenecks in particular data transmission paths by utilizing the links with increased bandwidth, thereby using all links in a balanced manner. The mesh-based FatMesh structure according to an embodiment may provide an efficient collective communication network for large-scale parallel operations.

The mesh-based FatMesh structure according to an embodiment may be a technology capable of being implemented and utilized in the form of a chip and/or software. The-based FatMesh structure may be applied to various systems as follows. The mesh-based FatMesh structure may be used in a network-on-chip (NoC) structure within a chip, an interconnection network of a chiplet structure for communication between chips, and an interconnection network connecting multiple reticles at wafer scale. For example, the mesh-based FatMesh structure according to an embodiment may be used to efficiently process collective communication, which may frequently occur in a system where many cores perform a single task in parallel or operate in a distributed manner by dividing the task.

Recently, a transformer structure, referred to as a large language model (LLM), follows a scaling law where performance improves in proportion to the size of a model's weight and a length of an input sequence. Based on this scaling law, the transformer model is being extended in various manners to implement a model with higher performance. However, in the case of an LLM that shows a certain level of performance or higher, the size of the model becomes too large, making it impossible to perform inference on a silicon chip implemented in a single reticle or single chip size, in addition to training of the model. Accordingly, dozens to hundreds or thousands of chips are connected to build a single, massive system, which is then used for training and inference.

In such large-scale systems, organic connections between chips may be required. For example, chip-to-chip communication may be required to perform training and inference by distributing models across tens or hundreds of chips. For example, chip-to-chip communication may be broadly divided into two types (or schemes): a peer-to-peer communication and a collective communication. In the peer-to-peer communication, which may be 1:1 communication between chips, the communication speed and delay time may be determined by the performance of the router, cable, and protocol connected between the chips. In the collective communication, which may be a many-to-many communication, operations or tasks such as data combination or distribution between multiple chips may be performed. The collective communication scheme may be greatly affected by the performance of routers and cables as well as the optimal path and communication algorithm of the topology in which the chips are connected.

The mesh-based FatMesh structure according to an embodiment may be efficiently implemented in network-on-chip (NoC), chiplet, and wafer scale structures and may use a two-dimensional (2D) mesh with high area utilization as a reference for physical topology. Therefore, a method of performing collective communication according to an embodiment may include collective communication in a 2D mesh structure. For example, the method of performing collective communication according to an embodiment may include performing an all-reduce operation algorithm that is most commonly used in an LLM.

The mesh-based FatMesh structure may provide a technology that allows efficient data communication in a large-scale parallel computing environment. The mesh-based FatMesh structure may alleviate data bottlenecks by increasing link bandwidth in a particular direction and maximize the utilization of network resources by utilizing all links. Hereinafter, a device including a mesh-based FatMesh structure according to an embodiment may be referred to as a mesh-based network device.

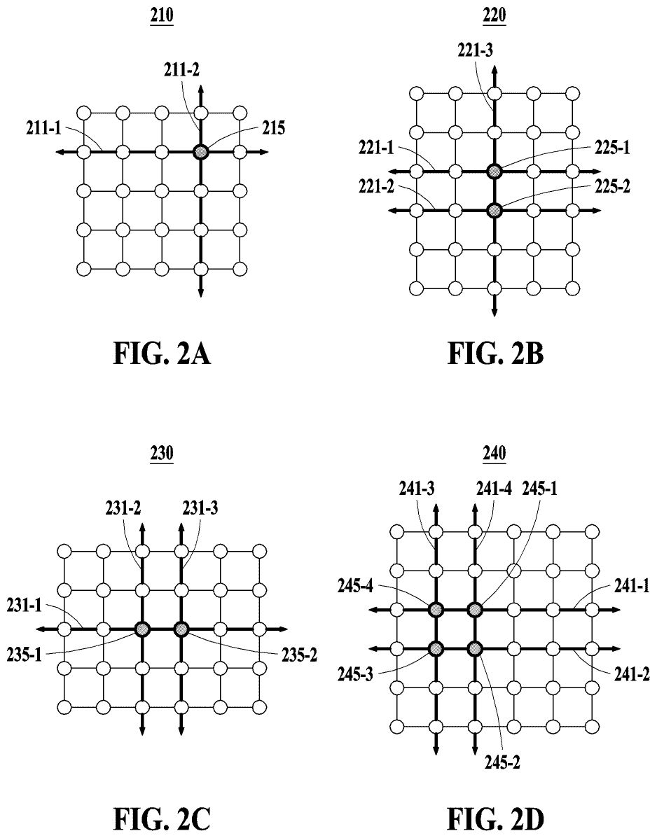

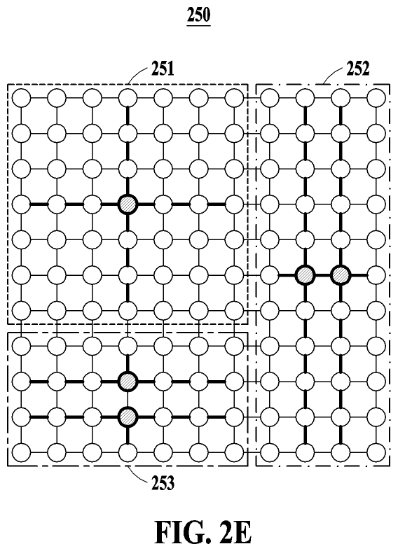

FIGS. 2A to 2E are diagrams illustrating a mesh-based network structure and examples thereof according to an embodiment. The description provided with reference to FIGS. 1A to 1D may be equally applied to FIGS. 2A to 2E.

The mesh-based FatMesh structure according to an embodiment may be implemented in a 2D mesh structure of N×M (where N and M are integers greater than “2”), and the number and location of root nodes may be determined according to the values of N and M. The mesh-based FatMesh structure may be designed to include links with increased bandwidth in a particular direction. The links with increased bandwidth may have an increased (e.g., twice increased) bandwidth than other links in the same direction, and a root node may be located at a cross point where the links intersect. In an example case in which both N and M are odd numbers, there may be only one root node, and in an example case in which N is an odd number and M is an even number. In another example case in which N is an even number and M is an odd number, there may be two root nodes. In another example case in which both N and M are even numbers, there may be four root nodes. The mesh-based FatMesh structure may utilize the links with increased bandwidth to alleviate bottlenecks in data transmission and utilize mesh network resources as efficiently as possible.

FIG. 2A is a diagram illustrating a mesh-based FatMesh structure 210 implemented in a 5×5 mesh network structure according to an embodiment. The mesh-based FatMesh structure 210 may be designed to include links with increased bandwidth in a particular direction. For example, links 211-1 and 211-2 may have bandwidths that are twice the bandwidth of other links in the same direction. For example, links 211-1 in a first direction (e.g., horizontal direction) may have bandwidths that are twice the bandwidth of other links in the first direction, and links 211-2 in a second direction (e.g., vertical direction) may have bandwidths that are twice the bandwidth of other links in the second direction. The links 211-1 and 211-2 with increased bandwidth may include a root node 215 located at cross points of the links 211-1 and 211-2. The root node 215 may be used as a reference point for performing collective communication in the network. In this process, all nodes may combine data using the root node or gather data from the root node.

FIG. 2B is a diagram illustrating a 5×6 mesh-based FatMesh structure 220 according to an embodiment. The mesh-based FatMesh structure 220 may include first links 221-1, second links 221-2 and third links 221-3. For example, the mesh-based FatMesh structure 220 may be configured to include the first links 221-1 and the second 221-2 with increased (e.g., twice increase) bandwidth as compared to other links in the same direction as the first links 221-1 and the second links 221-2. According to an embodiment, the first links 221-1 and the second links 221-2 may be arranged adjacent to each other (e.g., adjacent rows) in the even number direction of an N×M mesh when either N or M is the even number. However, the disclosure is not limited thereto, and as such, the mesh structure may include another chain of links between the first links 221-1 and the second 221-2 (e.g., the first links 221-1 and the second 221-2 may not be adjacent to each to each other). Also, the mesh-based FatMesh structure220 may be configured to include the links 221-3 with increased (e.g., twice) bandwidth in the odd number direction of the N×M mesh. Two root nodes 225-1 and 225-2 may be located at cross points where the first links 221-1 and the second links 221-2 intersect. Each root node may process the collective communication of the network in parallel to optimize the data transmission speed.

FIG. 2C is a diagram illustrating a 6×5 mesh-based FatMesh structure 230 according to an embodiment in which even number directions and odd number directions are reversed as compared to FIG. 2C. The mesh-based FatMesh structure 230 may include first links 231-1, second links 231-2, and third links 231-3 with an increased bandwidth as compares to other links in the mesh structure. For example, the second links 231-2 and and third links 231-3 may be provided in the even number direction, and two root nodes 235-1 and 235-2 may be arranged at the cross points. These root nodes 235-1 and 235-2 may be used to efficiently combine or distribute data within the mesh network.

FIG. 2D is a diagram illustrating a 6×6 mesh-based FatMesh structure 240 according to an embodiment, in which both N and M are even numbers. In this example, the 6×6 mesh-based FatMesh structure 240 may include first links 241-1, second links 241-2, third links 241-3, and fourth links 241-4 with increased bandwidth, and four root nodes 245-1, 245-2, 245-3, and 245-4. Each section of the network may separately combine or distribute data, thereby improving the data processing efficiency of the entire network.

FIG. 2E is a diagram illustrating an example in which a mesh-based FatMesh structure 250 is applied to only a portion of the areas of the network or where the entire mesh is divided to form multiple mesh-based FatMesh structure planes. For example, in the mesh-based FatMesh structure 250, three mesh-based FatMesh structure planes 251, 252, and 253 may be independently configured within the network. Each plane may include its own root node and may perform independent collective communication. This mesh-based FatMesh structure 250 may alleviate bottlenecks in data processing in a large-scale parallel computing environment and improve the performance of the entire network.

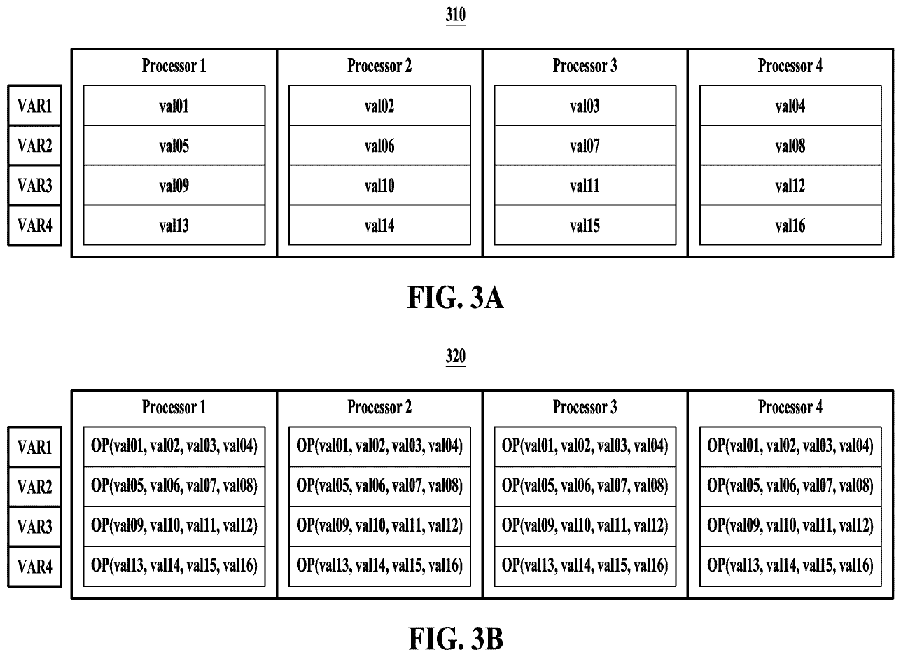

FIGS. 3A and 3B are diagrams illustrating a process in which four independent processors perform an all-reduce operation on four variables in an example case in which the four independent processors execute the same application according to an embodiment. The description provided with reference to previous figures (e.g., FIGS. 1A to 2E) may be equally applied to FIGS. 3A and 3B.

FIG. 3A illustrates an initial state 310, in which, each processor may independently store data values for each variable VAR.1, VAR.2, VAR.3, and VAR.4. For example, processor 1 may store values val01, val05, val09, and val13, and processor 2 may store values val02, val06, val10, and val14. Similarly, processor 3 may store values val03, val07, val11, and val15, and processor 4 may store values val04, val08, val12, and val16. As such, in the initial state 310, each processor may maintain independent values for the same set of variables.

FIG. 3B illustrates a result 320 of an all-reduce operation. The all-reduce operation may include a communication and computation process in which all processors perform the same operation (OP) on each variable to derive a final value. The OP( ) operation may be various operators such as addition, average, multiplication, and the like. For example, for variable VAR.1, processor 1 may calculate OP(val01, val02, val03, val04) to derive a final value. Similarly, OP(val05, val06, val07, val08) may be performed on variable VAR.2, and OP(val09, val10, val11, val12) and OP(val13, val14, val15, val16) may be performed on variables VAR.3 and VAR.4, respectively. These results 320 may be stored identically in each processor.

As shown in FIG. 3B, the all-reduce operation may allow all processors to have the same final value for the same set of variables, which may be used to efficiently process data synchronization and collective communication in a large-scale parallel computing environment. For example, since various OPs may be applied, this scheme may be utilized in the training and inference processes of machine learning (ML) and deep learning (DL) models. For example, an average OP may be used in the process of adding and distributing gradients, and a multiplication OP may be utilized in probability-based operations.

Collective communication of a ring structure, which is used in a 2D mesh, may have a latency that increases proportionally to the square of n in an n×n mesh as n increases and may have low bandwidth. On the other hand, in the case of three tree all-reduce (TTO), the mesh may be disassembled into a logical topology in the form of a tree, and three independent trees may each perform all-reduce. In this case, the latency may be measured as 2n−1 in proportion to the height of the tree. However, in the case of TTO, there may be a constraint that all trees are required to have independent links when configuring three trees. Since TTO may not use one of the n×n computing resources (e.g., GPU), it may have a negative impact on job parallelism. In addition, it may also impose restrictions on a software programming model.

As wafer-scale or chiplet structures spread, there may be an issue that the communication time becomes O(n²) as a diameter of the 2D mesh increases to O(n). Although TTO supports fast collective communication, one node may be unavailable, which may reduce the utilization of system resources.

There may also be a scheme in which 2D mesh and a folded torus structure are combined. According to this scheme, the latency increase may be proportional to 2n rather than proportional to the square. However, this structure may increase cost in that the structure requires an additional n×(n/2) links that skip two hops. In addition, although the ring structure reduces the complexity to O(n), it requires additional links, which may consume more resources in many aspects such as silicon cost, logic cost, and routing cost. Since the number of links increases in proportion to O(n), an additional cost burden may occur.

The mesh-based FatMesh structure according to an embodiment may arrange interconnects in a 2D mesh without incurring additional costs. The method of performing collective communication according to an embodiment may alleviate bottlenecks and allow efficient data processing in a large-scale parallel computation environment.

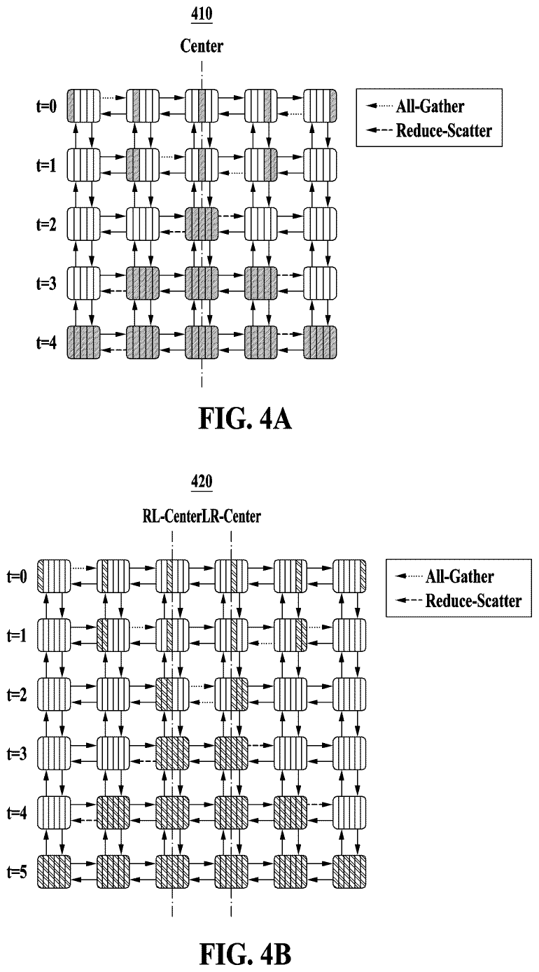

FIGS. 4A and 4B are diagrams illustrating a process of performing an all-reduce operation in a one-dimension (1D)-based network structure. The description provided with reference to the previous figures (e.g., FIGS. 1A to 3B) may be equally applied to FIGS. 4A and 4B.

According to an embodiment, a reduce-scatter operation may be a process in which each node transmits its data to adjacent nodes while simultaneously combining received data to progressively gather a portion of the data toward the center of the network. The reduce-scatter operation may reduce data bottlenecks and improve data combining efficiency in a large-scale parallel computing environment.

According to an embodiment, an all-gather operation may be a process of distributing the data combined at the center of the network back to each node such that all nodes have the same data. The all-gather operation may operate in a complementary manner with the reduce-scatter operation to effectively process data synchronization and distribution.

FIG. 4A illustrates a network 410 for illustrating a scheme in which data is progressively gathered to the center through a reduce-scatter operation based on the center, and distributed back to the network edge through an all-gather operation. This process is described in detail for each point in time as follows.

At t=0, as an initial state, each node may initiate a reduce-scatter operation by transmitting its data chunk to adjacent nodes. For example, a leftmost node in the network 410 may transmit a portion of its data to the right, and the right node may transmit data to the left. A dotted arrow may represent a direction in which the data moves.

At t=1, the reduce-scatter operation continues, and each node may combine the received data with its own data and transmit the combined data back to the adjacent nodes. In this process, the data may progressively converge to the central node and may be optimized to reduce bottlenecks throughout the network.

At t=2, data gathering at the center node is completed. The center node may be the root node. The data of all nodes may be combined and located at the center, and the center node may prepare an all-gather operation based on the combined data. The all-gather operation may include a process of distributing data from the center to the edges of the network.

At t=3, the all-gather operation begins, and the process of distributing data from the central node to each node may be performed. During this process, each node may receive data from the central node and may obtain a result integrated with its own data. A dashed arrow may represent a direction in which the data moves.

At t=4, the all-gather operation is completed, and all nodes may have the same data. This completes the all-reduce operation and may allow all nodes in the network to share the same data set.

FIG. 4B illustrates a network 420 for illustrating a scheme that utilizes a right-left center (RL-Center) and a left-right center (LR-Center) that are separated into left and right sides rather than based on the center. In this scheme, data may be combined into each of the two centers, and then distributed through an all-gather operation. The RL-Center and LR-Center scheme may efficiently use network bandwidth and provide non-overlapping communication paths for each data chunk. This process is described for each point in time as follows.

At t=0, t=1 and t=2, a reduce-scatter operation is performed similarly to example 410, and data may converge to the RL-Center and LR-Center, respectively. At t=3, data combining is completed at each center, and each center may prepare an all-gather operation based on the combined data. For example, the RL-Center may include all data obtained from nodes that are on the right and the left side of the RL-Center, and the LR-Center may include all data obtained from nodes that are on the right side and the left side of the LR-Center.

At t=4 and t=5, the all-gather operation of distributing data from the RL-Center and LR-Center to the edges of the network may be performed. In this process, all nodes may have the same data by integrating the data transmitted from both centers.

FIGS. 4A and 4B illustrate some embodiments in which the reduce-scatter operation and the all-gather operation may be performed with temporal overlap in the 1D-based FatMesh network. This scheme may improve network bandwidth utilization and reduce data communication latency. This scheme may be particularly useful in a large-scale parallel computing environment.

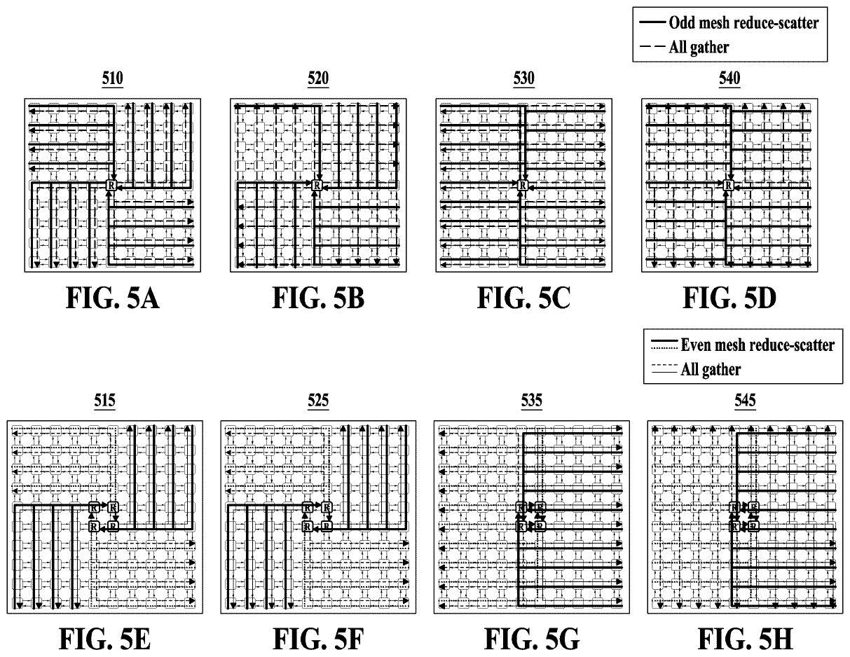

FIGS. 5A to 5H are diagrams example network structures for illustrating a process of performing an all-reduce operation in a 2D-based network structure.

FIGS. 5A to 5H illustrate how a reduce-scatter operation and an all-gather operation are performed in a 2D network structure, and how each operation may vary depending on the direction and the number of root nodes. The examples illustrated in FIGS. 5A to 5H provide details of each network configuration and operation scheme.

FIG. 5A shows a network structure 510 for illustrating a case in which a reduce-scatter operation and an all-gather operation are performed centered on one root node in an odd mesh network. The reduce-scatter operation may be performed as a process of gathering data from all nodes in the network to the root node.

FIG. 5B shows a network structure 520 for illustrating a case in which directions of the reduce-scatter operation and the all-gather operation are changed and performed centered on one root node in the odd mesh network. In this case, the data may converge to the root node through a different path, and the all-gather operation may distribute the data back to all nodes along that path. This may allow balanced utilization of the network bandwidth.

FIGS. 5C and 5D show network structures 530 and 540 respectively, for illustrating cases in which the reduce-scatter operation and the all-gather operation are performed in different directions in the odd mesh network, respectively. In the network structure 530, the reduce-scatter operation may be performed in a horizontal direction, and in the network structure 540, the reduce-scatter operation may be performed in a vertical direction. This difference in direction may be selected depending on a physical structure of the network or the data transmission requirements.

FIG. 5E shows a network structure 515 for illustrating a case in which the reduce-scatter operation and the all-gather operation are performed using four root nodes in an even mesh network. The reduce-scatter operation may be performed by gathering data from each area of the network to the corresponding root node, and then the data may be distributed to the entire network through the all-gather operation. Since multiple root nodes are used, the utilization of network resources may be increased.

FIG. 5F shows a network structure 525 for illustrating a case in which the reduce-scatter operation and the all-gather operation are performed in different directions in the even mesh network. In this case, data may move to different areas of the network, and may be gathered at each root node and distributed back to the network. This scheme may be effective in reducing data bottlenecks.

FIGS. 5G and 5H show network structures 535 and 545 respectively, for illustrating cases in which the reduce-scatter operation and the all-gather operation are performed through various paths in the even mesh network, respectively. In the network structures 535, the reduce-scatter operation may distribute data in a diagonal direction, and in the network structures 545, data may be distributed through a collaboration between root nodes. This scheme may maximize the structural characteristics of the network to increase data transmission efficiency.

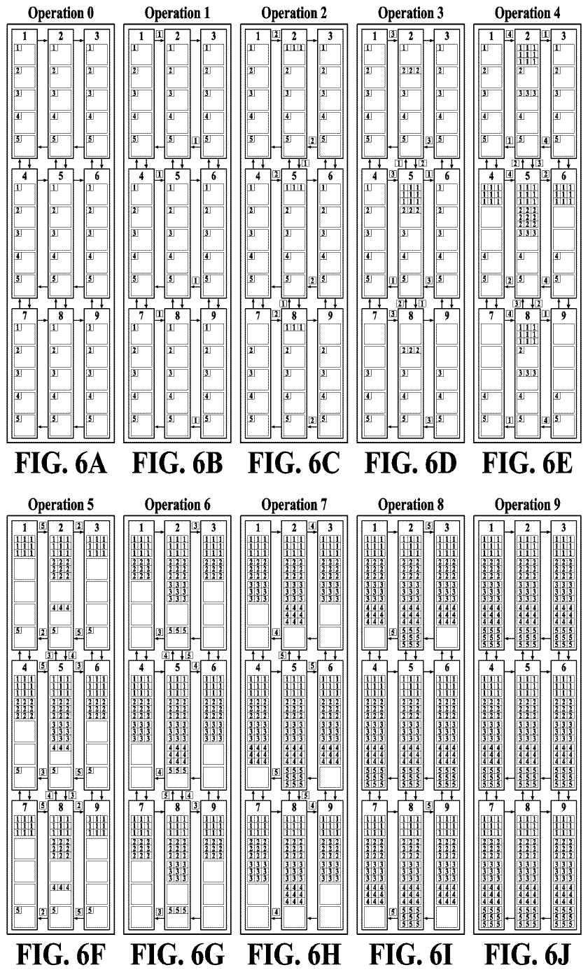

FIGS. 6A to 6J are diagrams illustrating a process of processing a message made up of five chunks in a 3×3 mesh-based network through an all-reduce operation.

FIGS. 6A to 6J illustrate a method of performing the reduce-scatter operation and the all-gather operation in temporal order and processing each operation by each of processors 1 to 9.

Referring to FIG. 6A, operation 0 may be an initial state, and in the initial state, each of the processors 1 to 9 in the network may retain data chunks assigned to themselves. For example, each processor may retain data chunks corresponding to variables 1 to 5. In operation 0, data movement does not occur yet, and each processor may maintain initial data in a ready state.

Referring to FIG. 6B, in operation 1, the reduce-scatter operation may begin, and each processor may transmit its data to an adjacent processor. For example, processor 1 may transmit a data chunk corresponding to its variable 1 to processor 2, processor 3 may transmit a data chunk corresponding to its variable 1 to processor 2, processor 4 may transmit a data chunk corresponding to its variable 1 to processor 5, processor 6 may transmit a data chunk corresponding to its variable 1 to processor 5, processor 7 may transmit a data chunk corresponding to its variable 1 to processor 5, and processor 9 may transmit a data chunk corresponding to its variable 1 to processor 5. In operation 1, the data may begin to move towards the center of the network, and data combining may be performed progressively.

Referring to FIG. 6C, in operation 2, the reduce-scatter operation may continue to be performed, and each processor may combine the data received from a previous operation and transmit the combined data back to the center. For example, processor 2 may combine the data chunks corresponding to variable 1 received from processor 1 and processor 3 and transmit the combined data chunks to processor 5. Similarly, processor 8 may combine the data chunks corresponding to variable 1 received from processor 7 and processor 9 and transmit the combined data chunks to processor 5.

Further, processor 1 may transmit a data chunk corresponding to its variable 2 to processor 2, processor 3 may transmit a data chunk corresponding to its variable 2 to processor 2, processor 4 may transmit a data chunk corresponding to its variable 2 to processor 5, processor 6 may transmit a data chunk corresponding to its variable 2 to processor 5, processor 7 may transmit a data chunk corresponding to its variable 2 to processor 5, and processor 9 may transmit a data chunk corresponding to its variable 2 to processor 5.

Referring to FIG. 6D, in operation 3, all data corresponding to variable 1 may be combined to processor 5, which is the root node of the network. For example, processor 5 may combine the data to generate a final combined data. For example, processor 5 may transmit the final combined data corresponding to variable 1 to processors 2, 4, 6, and 8 through the all-gather operation.

According to an embodiment, Processor 2 may combine the data chunks corresponding to variable 2 received from processor 1 and processor 3 and transmit the combined data chunks to processor 5. Similarly, processor 8 may combine the data chunks corresponding to variable 2 received from processor 7 and processor 9 and transmit the combined data chunks to processor 5.

Further, processor 1 may transmit a data chunk corresponding to its variable 3 to processor 2, processor 3 may transmit a data chunk corresponding to its variable 3 to processor 2, processor 4 may transmit a data chunk corresponding to its variable 3 to processor 5, processor 6 may transmit a data chunk corresponding to its variable 3 to processor 5, processor 7 may transmit a data chunk corresponding to its variable 3 to processor 5, and processor 9 may transmit a data chunk corresponding to its variable 3 to processor 5.

Referring to FIG. 6E, in operation 4, processors 2 and 8, which receive the final combined data corresponding to variable 1 through the all-gather operation, may transmit the final combined data to processors 1 and 3 and processors 7 and 9, respectively.

According to an embodiment, all data corresponding to variable 2 may be combined at processor 5, which is the root node of the network. Processor 5 may combine this data to generate the final combined data. For example, processor 5 may transmit the final combined data corresponding to variable 2 to processors 2, 4, 6, and 8 through the all-gather operation.

According to an embodiment, processor 2 may combine the data chunks corresponding to variable 3 received from processor 1 and processor 3 and transmit the combined data chunks to processor 5. Similarly, processor 8 may combine the data chunks corresponding to variable 3 received from processor 7 and processor 9 and transmit the combined data chunks to processor 5.

Further, processor 1 may transmit a data chunk corresponding to its variable 4 to processor 2, processor 3 may transmit a data chunk corresponding to its variable 4 to processor 2, processor 4 may transmit a data chunk corresponding to its variable 4 to processor 5, processor 6 may transmit a data chunk corresponding to its variable 4 to processor 5, processor 7 may transmit a data chunk corresponding to its variable 4 to processor 5, and processor 9 may transmit a data chunk corresponding to its variable 4 to processor 5.

Referring to FIG. 6F, in operation 5, processors 2 and 8, which receive the final combined data corresponding to variable 2 through the all-gather operation, may transmit the final combined data to processors 1 and 3 and processors 7 and 9, respectively.

According to an embodiment, all data corresponding to variable 3 may be combined at processor 5, which is the root node of the network. For example, processor 5 may combine this data to generate the final combined data. For example, processor 5 may transmit the final combined data corresponding to variable 3 to processors 2, 4, 6, and 8 through the all-gather operation.

According to an embodiment, processor 2 may combine the data chunks corresponding to variable 4 received from processor 1 and processor 3 and transmit the combined data chunks to processor 5. Similarly, processor 8 may combine the data chunks corresponding to variable 4 received from processor 7 and processor 9 and transmit the combined data chunks to processor 5.

Further, processor 1 may transmit a data chunk corresponding to its variable 5 to processor 2, processor 3 may transmit a data chunk corresponding to its variable 5 to processor 2, processor 4 may transmit a data chunk corresponding to its variable 5 to processor 5, processor 6 may transmit a data chunk corresponding to its variable 5 to processor 5, processor 7 may transmit a data chunk corresponding to its variable 5 to processor 5, and processor 9 may transmit a data chunk corresponding to its variable 5 to processor 5.

Referring to FIG. 6G, in operation 6, processors 2 and 8, which receive the final combined data corresponding to variable 3 through the all-gather operation, may transmit the final combined data to processors 1 and 3 and processors 7 and 9, respectively.

According to an embodiment, all data corresponding to variable 4 may be combined at processor 5, which is the root node of the network. For example, processor 5 may combine this data to generate the final combined data. For example, processor 5 may transmit the final combined data corresponding to variable 4 to processors 2, 4, 6, and 8 through the all-gather operation.

According to an embodiment, processor 2 may combine the data chunks corresponding to variable 5 received from processor 1 and processor 3 and transmit the combined data chunks to processor 5. Similarly, processor 8 may combine the data chunks corresponding to variable 5 received from processor 7 and processor 9 and transmit the combined data chunks to processor 5.

Further, processor 1 may transmit a data chunk corresponding to its variable 6 to processor 2, processor 3 may transmit a data chunk corresponding to its variable 6 to processor 2, processor 4 may transmit a data chunk corresponding to its variable 6 to processor 5, processor 6 may transmit a data chunk corresponding to its variable 6 to processor 5, processor 7 may transmit a data chunk corresponding to its variable 6 to processor 5, and processor 9 may transmit a data chunk corresponding to its variable 6 to processor 5.

Referring to FIG. 6H, in operation 7, processors 2 and 8, which receive the final combined data corresponding to variable 4 through the all-gather operation, may transmit the final combined data to processors 1 and 3 and processors 7 and 9, respectively.

According to an embodiment, all data corresponding to variable 5 may be combined at processor 5, which is the root node of the network. For example, processor 5 may combine this data to generate the final combined data. For example, processor 5 may transmit the final combined data corresponding to variable 5 to processors 2, 4, 6, and 8 through the all-gather operation.

Referring to FIG. 6I, in operation 8, processors 2 and 8, which receive the final combined data corresponding to variable 5 through the all-gather operation, may transmit the final combined data to processors 1 and 3 and processors 7 and 9, respectively.

Referring to FIG. 6J, in operation 9, the all-gather operation may be completed, and all processors in the network may retain the same data set. For example, all processors from processor 1 to processor 9 may completely receive the data from variable 1 to variable 5 and store the received data therein. This may allow all processes of the reduce-scatter operation and the all-gather operation to be completed.

The process illustrated in FIGS. 6A to 6J shows how communication between nodes is performed by dividing a large message into small data chunks in a 3×3 mesh network. Here, a chunk may be a basic unit of the communication between nodes and may be defined as the smallest unit of data that a node may transmit to an adjacent node through a particular edge.

In this 2D mesh network structure, four corner nodes of the network may have the smallest number of edges. Each corner node may be connected to two adjacent nodes, and in an example case in which data is transmitted from each corner node, each node may transmit data to only one adjacent node at a time. In this manner a possibility that edge utilization within the network may be reduced at a particular stage.

For example, in the example described above, the scheme where each node is configured to transmit data to only one adjacent node at a time may limit the parallel processing potential of the network. This may suggest that additional design improvements may be required to optimize overall network resource utilization in a large-scale parallel computing environment.

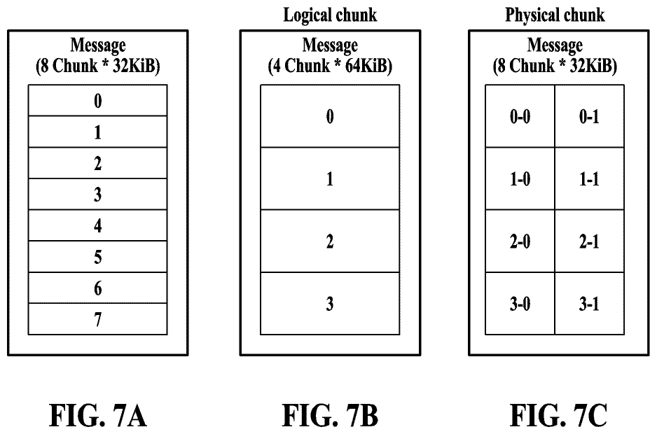

FIGS. 7A to 7C are diagrams illustrating the difference of a method of processing data in a mesh-based FatMesh structure according to various example schemes, which may indicate a change in logical chunk and physical chunk transmission schemes of data chunks making up a message.

Referring to FIG. 7A, in a related art scheme, a message may include 8 chunks, and each chunk may have a size of 32 KiB. Each chunk may be sequentially transmitted from a node to an adjacent node, and each chunk may be transmitted through one edge at a time. For example, to transmit all 8 chunks, a total of 8 transmissions may be required.

Referring to FIG. 7B, in the mesh-based FatMesh structure according to an embodiment of the disclosure, unlike the related art scheme, a message may be reconstructed into logical chunks to be processed. For example, a message including 8 chunks may be converted into 4 logical chunks. Here, each logical chunk may include 64 KiB of data, and the logical chunks may be divided again into physical chunks to be transmitted.

Referring to FIG. 7C, in the mesh-based FatMesh structure according to an embodiment of the disclosure, a logical chunk may be divided into two physical chunks, and each physical chunk may be transmitted simultaneously through two outgoing edges. For example, logical chunk 0 may be divided into physical chunks 0-0 and 0-1 and transmitted simultaneously to two adjacent nodes. In an example case in which each physical chunk is transmitted simultaneously through two outgoing edges, edge utilization may be improved, and data transmission efficiency may be increased.

In an example case in which each physical chunk is transmitted simultaneously through two outgoing edges, data transmission according to the related art scheme, which requires eight transmissions, may be reduced to four logical chunk transmissions. In addition, by dividing each logical chunk into two physical chunks and transmitting the physical chunks in parallel, the data transmission speed of the entire network may be significantly improved. This structural improvement may enable efficient utilization of network resources in a large-scale parallel computation environment and may alleviate bottlenecks.

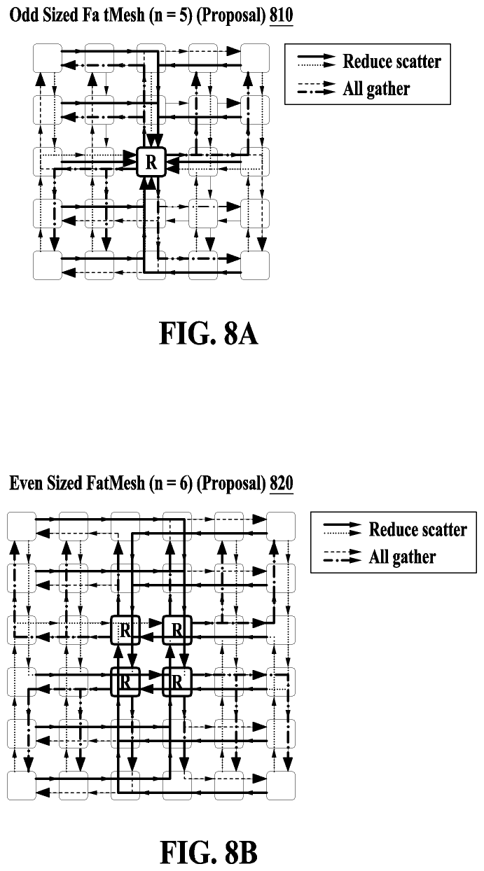

FIGS. 8A and 8B are diagrams illustrating a process of processing data through a reduce-scatter operation and an all-gather operation in a mesh-based FatMesh structure according to an embodiment.

In FIG. 8A, a mesh-based FatMesh structure 810 may be an odd-sized (n=5) FatMesh structure and in FIG. 8B a mesh-based FatMesh structure 820 may be an even-sized (n=6) FatMesh structure.

Referring to FIG. 8A, the odd-sized mesh-based FatMesh structure 810 may perform a reduce-scatter operation and an all-gather operation at a single root node (R) located at the center of the network. In the reduce-scatter operation, each node may transmit its data to an adjacent node, and the data may be progressively combined toward the center of the network. For example, two different chunks of physical chunks generated from each node may be transmitted simultaneously. Through this scheme, the network bandwidth may be balanced, and data bottlenecks may be alleviated. In the all-gather operation, the data combined at the root node may be distributed again toward the edge of the network, and the bandwidth of each link may be effectively utilized in this process.

Referring to FIG. 8B, the even-sized mesh-based FatMesh structure 820 may perform the reduce-scatter operation and the all-gather operation at multiple root nodes (4) located at the center of the network. In the reduce-scatter operation, each node may transmit data toward the center of the network, and the data may be combined at each root node. In this process, two different physical chunks may be transmitted simultaneously, which may optimize the network bandwidth. In the all-gather operation, the data combined at the centrally located root nodes may be distributed to the edges of the network. This process may allow the same physical chunk to be transmitted with higher bandwidth (e.g., twice the bandwidth), thereby reducing data transmission latency.

According to an embodiment, the mesh-based FatMesh structure may be configured or designed such that, unlike related art networks, there are no unused links within the network. This may indicate that all links are used to transmit data, which may maximize the efficiency of network resources. In addition, the location of the root nodes may be arranged at the shortest distance from all nodes, which may optimize the data transmission paths. These structural characteristics may provide an opportunity to efficiently utilize the network bandwidth and minimize data transmission latency.

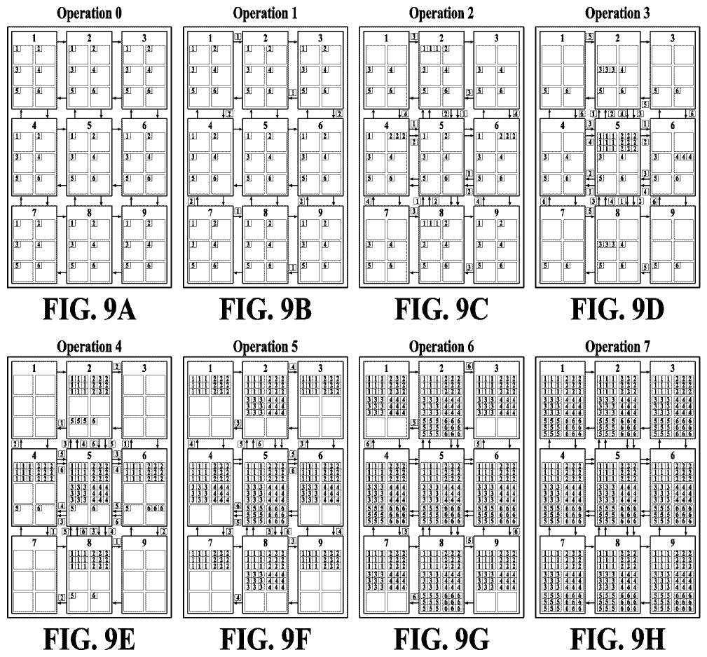

FIGS. 9A to 9H are diagrams illustrating a method of processing a message made up of five chunks through an all-reduce operation in a 3×3 mesh-based FatMesh network structure, according to an embodiment.

The description related to FIGS. 9A to 9H may explain in detail how the reduce-scatter operation and the all-gather operation are performed in temporal order and how each operation is processed by each of processors 1 to 9.

Referring to FIG. 9A, operation 0 may be an initial state, and in the initial state, each of the processors 1 to 9 in the network may retain data chunks assigned to themselves. For example, each processor may retain data chunks corresponding to variables 1 to 6. In operation 0, data movement does not occur yet, and each processor may maintain the initial data in a ready state.

Referring to FIG. 9B, in operation 1, the reduce-scatter operation may begin, and each processor may transmit its data to an adjacent processor. For example, processor 1 may transmit a data chunk corresponding to its variable 1 to processor 2 and simultaneously transmit a data chunk corresponding to its variable 2 to processor 4, processor 3 may transmit a data chunk corresponding to its variable 1 to processor 2 and simultaneously transmit a data chunk corresponding to its variable 2 to processor 6, processor 7 may transmit a data chunk corresponding to its variable 1 to processor 8 and simultaneously transmit a data chunk corresponding to its variable 2 to processor 4, and processor 9 may transmit a data chunk corresponding to its variable 1 to processor 8 and simultaneously transmit a data chunk corresponding to its variable 2 to processor 6. In operation 1, the data may begin to move towards the center of the network, and data combining may be performed progressively.

Referring to FIG. 9C, in operation 2, the reduce-scatter operation may continue to be performed, and each processor may combine the data received from a previous operation and transmit the combined data back to the center. For example, processor 2 may combine the data chunks corresponding to variable 1 received from processor 1 and processor 3 and transmit the combined data chunks to processor 5. Similarly, processor 8 may combine the data chunks corresponding to variable 1 received from processor 7 and processor 9 and transmit the combined data chunks to processor 5. Additionally, processor 4 and processor 6 may transmit the data chunks corresponding to its variable 1 to processor 5.

Further, processor 4 may combine the data chunks corresponding to variable 2 received from processor 1 and processor 7 and transmit the combined data chunks to processor 5. Similarly, processor 6 may combine the data chunks corresponding to variable 2 received from processor 3 and processor 9 and transmit the combined data chunks to processor 5. Additionally, processor 2 and processor 8 may transmit the data chunks corresponding to its variable 2 to processor 5.

For example, processor 1 may transmit a data chunk corresponding to its variable 3 to processor 2 and simultaneously transmit a data chunk corresponding to its variable 4 to processor 4, processor 3 may transmit a data chunk corresponding to its variable 3 to processor 2 and simultaneously transmit a data chunk corresponding to its variable 4 to processor 6, processor 7 may transmit a data chunk corresponding to its variable 3 to processor 8 and simultaneously transmit a data chunk corresponding to its variable 4 to processor 4, and processor 9 may transmit a data chunk corresponding to its variable 3 to processor 8 and simultaneously transmit a data chunk corresponding to its variable 4 to processor 6.

Referring to FIG. 9D, in operation 3, all data corresponding to variables 1 and 2 may be combined to processor 5, which is the root node of the network. For example, processor 5 may combine this data to generate the final combined data. For example, processor 5 may transmit the final combined data corresponding to variables 1 and 2 to processors 2, 4, 6, and 8 through the all-gather operation.

For example, processor 2 may combine the data chunks corresponding to variable 3 received from processor 1 and processor 3 and transmit the combined data chunks to processor 5. Similarly, processor 8 may combine the data chunks corresponding to variable 3 received from processor 7 and processor 9 and transmit the combined data chunks to processor 5. Additionally, processor 4 and processor 6 may transmit the data chunks corresponding to its variable 3 to processor 5.

Further, processor 4 may combine the data chunks corresponding to variable 4 received from processor 1 and processor 7 and transmit the combined data chunks to processor 5. Similarly, processor 6 may combine the data chunks corresponding to variable 4 received from processor 3 and processor 9 and transmit the combined data chunks to processor 5. Additionally, processor 2 and processor 8 may transmit the data chunks corresponding to its variable 4 to processor 5.

For example, processor 1 may transmit a data chunk corresponding to its variable 5 to processor 2 and simultaneously transmit a data chunk corresponding to its variable 6 to processor 4, processor 3 may transmit a data chunk corresponding to its variable 5 to processor 2 and simultaneously transmit a data chunk corresponding to its variable 6 to processor 6, processor 7 may transmit a data chunk corresponding to its variable 5 to processor 8 and simultaneously transmit a data chunk corresponding to its variable 6 to processor 4, and processor 9 may transmit a data chunk corresponding to its variable 5 to processor 8 and simultaneously transmit a data chunk corresponding to its variable 6 to processor 6. In operation 3, the data may begin to move towards the center of the network, and data combining may be performed progressively.

Referring to FIG. 9E, in operation 4, all data corresponding to variables 3 and 4 may be combined to processor 5, which is the root node of the network. For example, processor 5 may combine this data to generate the final combined data. For example, processor 5 may transmit the final combined data corresponding to variables 3 and 4 to processors 2, 4, 6, and 8 through the all-gather operation.

For example, processor 2 may combine the data chunks corresponding to variable 5 received from processor 1 and processor 3 and transmit the combined data chunks to processor 5. Similarly, processor 8 may combine the data chunks corresponding to variable 5 received from processor 7 and processor 9 and transmit the combined data chunks to processor 5. Additionally, processor 4 and processor 6 may transmit the data chunks corresponding to its variable 5 to processor 5.

Further, processor 4 may combine the data chunks corresponding to variable 6 received from processor 1 and processor 7 and transmit the combined data chunks to processor 5. Similarly, processor 6 may combine the data chunks corresponding to variable 6 received from processor 3 and processor 9 and transmit the combined data chunks to processor 5. Additionally, processor 2 and processor 8 may transmit the data chunks corresponding to its variable 6 to processor 5.

For example, processors 2, 4, 6, and 8, which receive the final combined data corresponding to variable 1 through the all-gather operation, may transmit the final combined data to processors 1, 7, 3, and 9, respectively. Similarly, processors 2, 4, 6, and 8, which receive the final combined data corresponding to variable 2 through the all-gather operation, may transmit the final combined data to processors 3, 1, 9, and 7, respectively.

Referring to FIG. 9F, in operation 5, all data corresponding to variables 5 and 6 may be combined to processor 5, which is the root node of the network. For example, processor 5 may combine this data to generate the final combined data. For example, processor 5 may transmit the final combined data corresponding to variables 5 and 6 to processors 2, 4, 6, and 8 through the all-gather operation.

For example, processors 2, 4, 6, and 8, which receive the final combined data corresponding to variable 3 through the all-gather operation, may transmit the final combined data to processors 1, 7, 3, and 9, respectively. Similarly, processors 2, 4, 6, and 8, which receive the final combined data corresponding to variable 4 through the all-gather operation, may transmit the final combined data to processors 3, 1, 9, and 7, respectively.

Referring to FIG. 9G, in operation 6, processors 2, 4, 6, and 8, which receive the final combined data corresponding to variable 5 through the all-gather operation, may transmit the final combined data to processors 1, 7, 3, and 9, respectively. Similarly, processors 2, 4, 6, and 8, which receive the final combined data corresponding to variable 6 through the all-gather operation, may transmit the final combined data to processors 3, 1, 9, and 7, respectively.

Referring to FIG. 9H, in operation 7, the all-gather operation may be completed, and all processors in the network may retain the same data set. For example, all processors from processor 1 to processor 9 may completely receive the data from variable 1 to variable 6 and store the received data therein. This may allow all processes of the reduce-scatter operation and the all-gather operation to be completed.

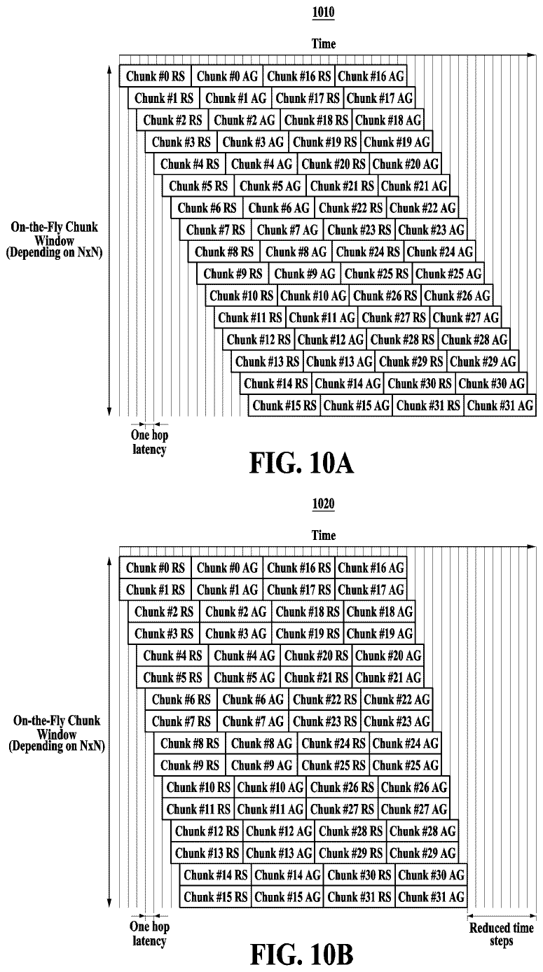

FIGS. 10A and 10B are diagrams showing a graphical representation of an overlap in a time axis of a reduce-scatter operation and an all-gather operation.

Referring to FIG. 10A, a graphical representation 1010 illustrates an overlapping process of the reduce-scatter operation and the all-gather operation in an example case in which each node of a mesh network structure transmits data to one adjacent node at a time, and a graphical representation 1020 illustrates an overlapping process of the reduce-scatter operation and the all-gather operation in an example case in which each node of a mesh-based FatMesh structure transmits data to two adjacent nodes at a time.

Referring to the graphical representation 1010 in FIG. 10A, in an example case in which each node transmits data to one adjacent node at a time, each chunk may perform the reduce-scatter (RS) operation and the all-gather (AG) operation sequentially. For example, the AG operation of chunk 0 may begin only after the RS operation of that chunk is completed, and the RS operation of another chunk (e.g., chunk 1) may not overlap in the meantime. In this sequential structure, each chunk may individually occupy one-hop latencies, and the overall data processing time may increase in proportion to the number of chunks. As a result, in an example case in which each node transmits data to one adjacent node at a time, an issue may occur where the final operation completion time increases significantly as the number of chunks increases.

Referring to the graphical representation 1020 in FIG. 10B, the mesh-based FatMesh structure according to an embodiment may be designed such that each node may transmit data to two adjacent nodes at a time. This may allow RS operations and AG operations to overlap simultaneously. For example, RS operations for chunks 0 and 1 may be performed in parallel, and AG operations for chunks 16 and 17 may also be performed in parallel at the same time. In an example case in which each node transmits data to two adjacent nodes at a time, the overall data processing time may be significantly reduced by parallelizing the processing operations of each chunk.

Comparing the graphical representation 1010 and the graphical representation 1020, in an example case in which each node transmits data to two adjacent nodes at a time, the operation completion time may be reduced compared to the related art scheme when the same number of chunks are processed. Each node may transmit data to two adjacent nodes at a time by maintaining bandwidth balance and parallelizing operations in the mesh-based FatMesh structure, thereby improving link utilization of the network and minimizing data transmission latency. For example, in example 1020, all chunks may complete RS and AG operations more quickly, enabling more efficient data processing compared to the related art scheme.

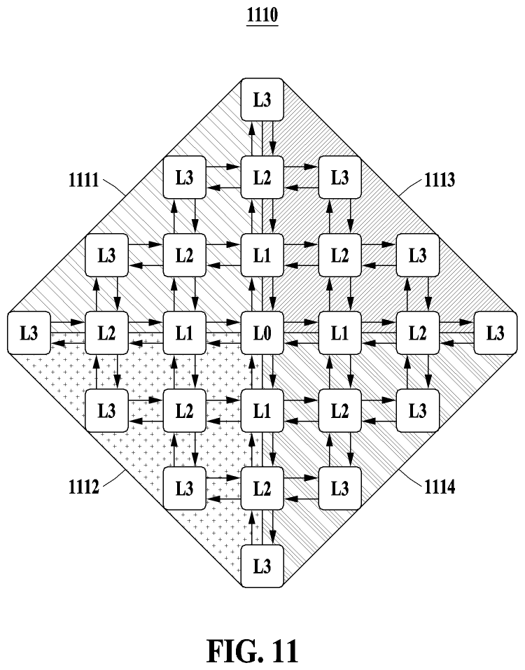

FIG. 11 is a diagram illustrating an example of a 2D FatMesh network structure according to an embodiment. The description provided with reference to FIGS. 1 to 10 may be equally applied to FIG. 11.

Referring to FIG. 11, the 2D FatMesh network structure 1110 shows a rhombus-shaped network design in which each area has an independent tree-like structure, and example 1120 shows a connection structure centered around a central root node R.

According to an embodiment, the 2D FatMesh network structure 1110 may be configured as a rhombus-shaped 2D FatMesh structure. The network may be divided into four independent areas 1111, 1112, 1113, and 1114, and each area may perform independent data processing through a tree-like structure. The tree-like structure may minimize the links and nodes of the network while increasing data transmission efficiency. The rhombus-shaped 2D FatMesh structure may assign and perform independent jobs in the independent areas 1111, 1112, 1113, and 1114. As a result, the rhombus-shaped 2D FatMesh structure may provide a structure capable of maintaining high data throughput while efficiently utilizing network resources.

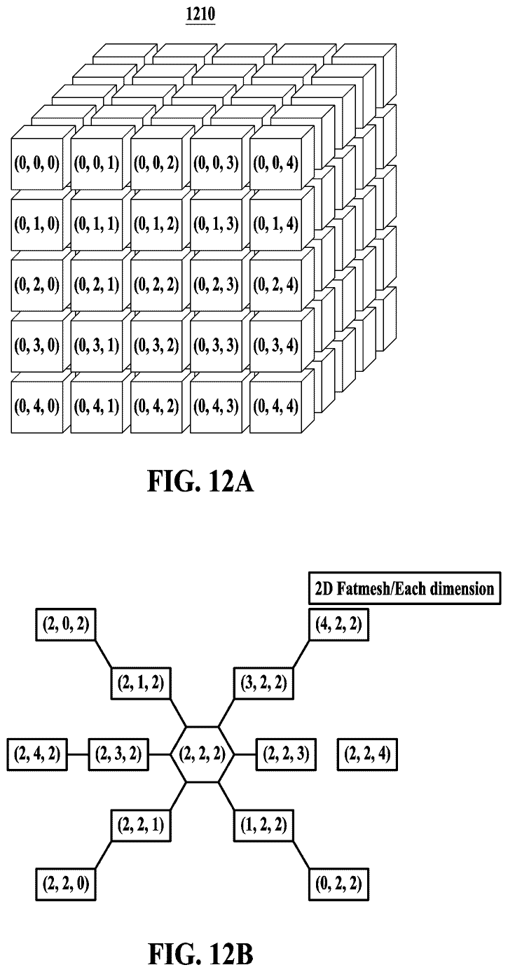

FIGS. 12A and 12B are diagrams illustrating a three-dimensional (3D) FatMesh structure 1210. The description provided with reference to the previous figures (e.g., FIGS. 1A to 11) may be equally applied to FIGS. 12A and 12B.

In FIG. 12A, the 3D FatMesh network structure 1210 includes nodes making up a 3D network and a connection structure between each node. FIG. 12B a data transmission direction for each dimension of the 3D FatMesh network. In an example case in which a 2D FatMesh structure is extended to 3D, the number of data chunks that may be processed and transmitted at each node may increase, which may lead to improvement in network performance.

Referring to FIG. 12A, the 3D FatMesh structure 1210 may include a plurality of nodes based on X, Y, and Z axes. For example, each node may be expressed as (x, y, z), which may represent the coordinates of a corresponding node. As shown in FIG. 12A, the nodes from (0, 0, 0) to (4, 4, 4) may form a network. The 3D FatMesh structure 1210 may expand the scheme of simultaneously transmitting two data chunks used in the related art 2D FatMesh to provide a structure that transmits three data chunks in parallel.

FIG. 12B illustrates the data transmission direction for each node in the 3D FatMesh structure. For example, based on a root node (2, 2, 2), data may be transmitted to adjacent nodes in each dimension X, Y, and Z. This may indicate that data is efficiently processed through the reduce-scatter operation and the all-gather operation, similar to the 2D FatMesh structure. In the 3D FatMesh structure 1210, each node may transmit data in three directions, so the data processing speed may be further improved compared to the 2D FatMesh structure.

For example, in the 3D FatMesh structure 1210, the utilization of network bandwidth may be further increased by dividing the data chunks from the related art two into three data chunks and transmitting them. For example, a data chunk starting from the (2, 2, 2) node may be transmitted to the adjacent nodes in each dimension simultaneously, thereby improving the data processing efficiency of the entire network. This approach may be expected to provide greater performance improvements compared to the 2D mesh structure and may provide advantages in a large-scale parallel computing environment.

Therefore, the 3D FatMesh structure 1210 may be an effective network designing scheme that may overcome the limitations of the 2D mesh structure and provide higher bandwidth utilization and lower data transmission latency, and may be applied to large-scale data processing tasks such as artificial intelligence (AI) model training and inference.

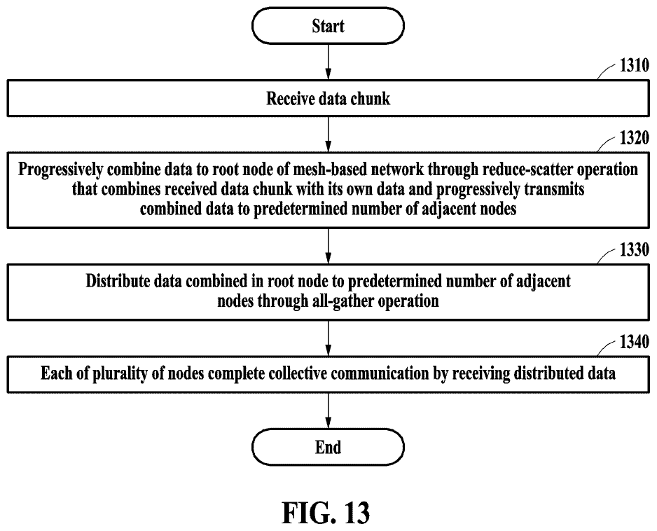

FIG. 13 is a diagram illustrating a method of performing collective communication according to an embodiment. The description provided with reference to FIGS. 1 to 12 may be equally applied to FIG. 13.

The operations illustrated in FIG. 13 may be performed in the order and manner illustrated, but the disclosure is not limited thereto, and as such, the order of some operations may be changed or some operations may be omitted without departing from the spirit and scope of the illustrated embodiment. A plurality of operations illustrated in FIG. 13 may be performed in parallel or simultaneously.

In operation 1310, each of a plurality of nodes included in a mesh-based network according to an embodiment may receive a data chunk. The mesh-based network may set a bandwidth of a link or a chain of links in a particular direction to an increased value compared to a bandwidth of another link or another chain of links in the same direction. Each of the plurality of nodes may partition the data chunk into logical chunks and transmit the logical chunks to each physical link.

In operation 1320, each of the plurality of nodes included in the mesh-based network according to an embodiment may progressively combine data to a root node of the mesh-based network through a reduce-scatter operation that combines the received data chunk with its own data and progressively transmits the combined data to a predetermined number of adjacent nodes. For example, each of the plurality of nodes may combine the received data chunk with its own data and transmit the combined data to two adjacent nodes. The root node may be located at a cross point where the links with increased bandwidth intersect.

In operation 1330, each of the plurality of nodes included in the mesh-based network according to an embodiment may distribute the data combined in the root node to a predetermined number of adjacent nodes through an all-gather operation.

In operation 1340, each of the plurality of nodes included in the mesh-based network according to an embodiment may complete collective communication by receiving the distributed data. The mesh-based network may transmit data chunks using all links in the mesh-based network as data transmission paths. Each of the plurality of nodes may perform the reduce-scatter operation and the all-gather operation for different data chunks simultaneously.

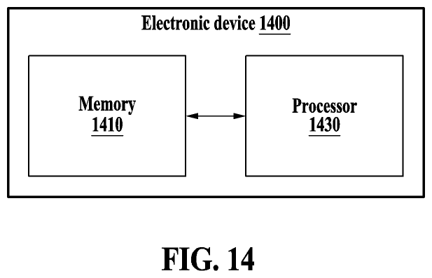

FIG. 14 is a diagram illustrating an electronic device according to an embodiment. The description provided with reference to FIGS. 1A to 13 may be substantially equally applied to FIG. 14.

Referring to FIG. 14, an electronic device 1400 may include memory 1410 and a processor 1420. The electronic device 1400 according to an embodiment may be a device capable of including a mesh-based network structure. The electronic device 1400 may include various computing devices such as, but not limited to, a mobile phone, a smartphone, a tablet, a camera device, an e-book device, a laptop, a personal computer, a desktop, a workstation or a server, various wearable devices such as a smartwatch, smart glasses, a head-mounted display (HMD), or smart clothes, various home appliances such as a smart television (TV) or a smart refrigerator, a smart car, a smart kiosk, and an Internet of Things (IoT) device, a walking assist device (WAD), a drone, or a robot.

The memory 1410 may store instructions (e.g., programs) executable by the processor 1420. For example, the instructions may include instructions for executing operations of the processor 1420 and/or operations of each component of the processor 1420.

The memory 1410 may be implemented as a volatile memory device or a non-volatile memory device.

The volatile memory device may be implemented as a dynamic random access memory (DRAM), a static random access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase-change RAM (PRAM), a resistive RAM (RRAM), a nanotube RRAM, a polymer RAM (PoRAM), a nano-floating gate memory (NFGM), a holographic memory, a molecular electronic memory device, or an insulator resistance change memory.

The processor 1420 may process data stored in the memory 1410. The processor 1420 may execute computer-readable code (e.g., software) stored in the memory 1410 and instructions caused by the processor 1420.

The processor 1420 may be a hardware-implemented data processing device including circuitry having a physical structure for executing desired operations. For example, the desired operations may include code or instructions included in a program.

For example, the hardware-implemented data processing device may include a microprocessor, a central processing unit, a processor core, a multi-core processor, a multiprocessor, an application-specific integrated circuit (ASIC), or a field programmable gate array (FPGA).

The processor 1420 may receive a data chunk, progressively combine data to a root node of a mesh-based network through a reduce-scatter operation that combines the received data chunk with its own data and progressively transmits the combined data to a predetermined number of adjacent nodes, distribute the data combined in the root node to a predetermined number of adjacent nodes through an all-gather operation, and complete collective communication by receiving the distributed data. The processor 1420 may perform substantially the same operations described with reference to FIGS. 1A to 13. Therefore, a detailed description thereof is omitted.

The embodiments described herein may be implemented using hardware components, software components and/or combinations thereof. A processing device may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuitry are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A system comprising:
a plurality of nodes arranged in rows and columns in a mesh-based network; and
a plurality of links configured to connect the plurality of nodes, the plurality of links comprising first links in a first direction and second links in a second direction, the first direction being one of a row direction or a column direction and the second direction being the other of the row direction or a column direction,
wherein at least one of the first links and the second links has a first bandwidth different than a second bandwidth of third links, among the plurality of links, wherein one or more nodes, among the plurality of nodes, located at cross points of the first links and the second links are defined as one or more root nodes, and
wherein the one or more root nodes are configured to perform collective communication performed between the plurality of nodes.

2. The system of claim 1, wherein the first links are arranged between adjacent nodes connected in the row direction or the column direction of the mesh-based network.

3. The system of claim 2, wherein,
based on a number of the rows or a number of columns of the mesh-based network being an even number, the first links comprise first first links and second first links arranged in two adjacent rows or two adjacent columns having the even number.

4. The system of claim 2, wherein,
based on a number of the rows or a number of columns of the mesh-based network being an odd number, the first links are arranged only in one of the rows or the columns having the odd number.

5. The system of claim 1, wherein the mesh-based network is divided into a plurality of sections, each of the plurality of sections comprising a root node, among the one or more root nodes, and
wherein the root node of each of the plurality of sections is configured to process collective communication performed within a corresponding section.

6. The system of claim 1, wherein the mesh-based network comprises a plurality of lower level nodes hierarchically connected to each of the one or more root nodes, and
wherein the plurality of lower level nodes form a hierarchical tree structure.

7. The system of claim 1, wherein the mesh-based network comprises a mesh network expanded to a three-dimensional (3D) structure, and
wherein the 3D mesh network comprises connections between the plurality of nodes arranged in a 3D direction.

8. A system comprising:
a plurality of nodes arranged in rows and columns in a mesh-based network; and
a plurality of links configured to connect the plurality of nodes, the plurality of links comprising first links in a first direction and second links in a second direction, the first direction being one of a row direction or a column direction and the second direction being the other of the row direction or a column direction,
wherein at least one of the first links and the second links has a first bandwidth different than a second bandwidth of third links, among the plurality of links, and
wherein each of the plurality of nodes is configured to:
receive a data chunk,
perform reduce-scatter operation of progressively combining the received data chunk with its own data and progressively transmitting the combined data to a root node of the mesh-based network through a number of adjacent nodes,
perform an all-gather operation of distributing first data combined in the root node to a number of adjacent nodes, and
complete collective communication by receiving second data distributed from the root node.

9. The system of claim 8, wherein each of the plurality of nodes is further configured to simultaneously perform the reduce-scatter operation and the all-gather operation for different data chunks.

10. The system of claim 8, wherein the root node is located at cross points of the first links and the second links.

11. The system of claim 8, wherein each of the plurality of nodes is further configured to partition the data chunk into logical chunks and transmit the logical chunks to each physical link.

12. The system of claim 8, wherein each of the plurality of nodes is further configured to simultaneously transmit two physical chunks to different adjacent nodes.

13. The system of claim 8, wherein at least one of the first links and the second links has a first bandwidth different than a second bandwidth of third links, among the plurality of links.

14. The system of claim 8, wherein the plurality of nodes is further configured to transmit the data chunk using all of the plurality of links as data transmission paths.

15. A method of performing collective communication, the method comprising:
receiving a data chunk by each of a plurality of nodes connected to each other by a plurality of links in a mesh-based network, the plurality of links including first links in a first direction and second links in a second direction, the first direction being one of a row direction or a column direction and the second direction being the other of the row direction or a column direction;
performing, by each of the plurality of nodes, reduce-scatter operation of progressively combining the received data chunk with its own data and progressively transmitting the combined data to a root node of the mesh-based network through a number of adjacent nodes;
perfoming, by each of the plurality of nodes, an all-gather operation of distributing first data combined in the root node to a number of adjacent nodes; and
completing, by each of the plurality of nodes, collective communication by receiving second data distributed from the root node,
wherein at least one of the first links and the second links has a first bandwidth different than a second bandwidth of third links, among the plurality of links.

16. The method of claim 15, wherein the reduce-scatter operation and the all-gather operation are for different data chunks.

17. The method of claim 15, wherein the root node is located at cross points of the first links and the second links.

18. The method of claim 15, further comprising:
partitioning the data chunk into logical chunks; and
transmitting the logical chunks to each physical link.

19. The method of claim 15, wherein the completing of the collective communication comprises transmitting the data chunk using all of the plurality of links of the mesh-based network as data transmission paths.

20. The method of claim 15, wherein the first links are arranged between adjacent nodes connected in the row direction or the column direction of the mesh-based network.
